(19) United States
(12) Patent Application Publication
(10) Pub. No.: US 2022/0154391 A1
(43) Pub. Date: May 19, 2022

(54) COMPOSITES OF POLYMERIC ULTRAFINE FIBERS AND SHEAR-THICKENING FLUIDS

(71) Applicant: Massachusetts Institute of Technology, Cambridge, MA (US)

(72) Inventors: Gregory C. Rutledge, West Newton, MA (US); Junli Hao, Cambridge, MA (US)

(21) Appl. No.: 17/526,655

(22) Filed: Nov. 15, 2021

Related U.S. Application Data
(60) Provisional application No. 63/113,504, filed on Nov. 13, 2020.

(51) Int. Cl. D06M 11/79; D04H 1/728; D06M 15/53; C08G 69/26; D04H 1/4291; D04H 1/4342; D04H 1/4334; C08L 71/02; D06M 101/20; D06M 101/34; D06M 101/36

(52) U.S. Cl. CPC D06M 11/79; D04H 1/728; D06M 15/53; C08G 69/26; D04H 1/4291; D04H 1/4342; D06M 2101/36; C08L 71/02; C08L 2205/02; D06M 2101/20; C08L 2203/12; D06M 2101/34; D04H 1/4334

(57) ABSTRACT

The present disclosure relates to fabrics and articles of clothing related thereto. The present disclosure also relates to methods of preparing the fabrics disclosed herein.

### RELATED APPLICATIONS

This application claims the benefit of priority to U.S. Provisional Application No. 63/113,504, filed Nov. 13, 2020.

### BACKGROUND

Since the dawn of time, people have clothed themselves with protective clothing in an attempt to shield their bodies from injury. Initially, this armor was made of naturally occurring materials such as animal skins, leathers, bamboo, wood and combinations thereof. However, these early armors possessed multiple disadvantages. For example, the materials from which the armor were constructed were difficult to work with. Furthermore, the armor was heavy, bulky, and it did not provide much protection to higher levels of impact. A substantial improvement to body armor occurred with the discovery of metals and the development of manufacturing methods to manipulate metal. Body armor made of metal afforded substantial improvements to impact resistance over earlier armors. However, while metallic body armor has extremely high impact resistance, it comes at the cost of being extremely heavy and inflexible. More recently a soft armor comprising 15-20 layers of a fabric known as Kevlar was developed. However, while more flexible than metal armor, Kevlar still has very limited flexibility as compared to traditional clothing. Moreover, Kevlar provides little protection against higher-velocity and higher-impact projectiles, such as rifle rounds, as well as some relatively lower-velocity threats such a stabbing. In view of the foregoing, there remains an ongoing need for strong, yet flexible and lightweight materials for use in the construction of protective articles of clothing (e.g., protective sportswear, safety equipment, body armor, and the like).

### SUMMARY OF THE INVENTION

In one aspect, the present disclosure relates to fabrics comprising a plurality of polymer fibers and a shear-thickening fluid; wherein the polymer fibers have a diameter from 1-1,500 nm; the shear-thickening fluid comprises a plurality of nanoparticles or aggregates, and a suspending liquid. In another aspect, the present disclosure relates to articles of clothing comprising a fabric of the disclosure. In yet another aspect, the present disclosure relates to methods of preparing the fabrics of the disclosure.

### BRIEF DESCRIPTION OF THE DRAWINGS

FIGS. 1A-1C depict the mechanical properties of certain exemplary sheer thickening fluids.

FIGS. 2A & 2B are TEM images of NP100-200 particles of different aggregate sizes show at certain magnification levels.

FIGS. 2C & 2D are TEM images of FS particles of different aggregate sizes show at certain magnification levels.

FIG. 3A is an SEM image of PA6(3)T fibers electrospun from a 30% solution in 100:1 DMF:FA.

FIG. 3B is an SEM image of PA6,6 fibers electrospun from a 15% solution in 3:2 FA:DCM.

FIG. 4A-4C illustrates an exemplary fabrication process of STF-UFF compositions. In each of FIGS. 4A-4C, four samples are shown: 65% wt. NP100-200/PEG-400 (top left), 15% wt. FS/PPG (top right), 18% wt. FS/PPG (bottom left), and 20% wt. FS/PPG (bottom right). FIG. 4A shows the as-spun membranes. FIG. 4B shows the membranes saturated with ethanol-diluted STFs. FIG. 4C shows the compositions after the ethanol has evaporated.

FIG. 5 depicts the stress-strain curves of exemplary compositions, with each curve representing one sample. Multiple replicates are shown for each composition. The insert illustrates the 2 regions of the tensile stress response.

FIG. 6A is an SEM image of failure surfaces after tensile tests of as-spun membranes. The arrow indicates the direction of the applied load during tensile testing, which was perpendicular to the failure surface.

FIG. 6B is an SEM image of failure surfaces after tensile tests of a NP100-200 STF-UFF composite. The arrow indicates the direction of the applied load during tensile testing, which was perpendicular to the failure surface.

FIG. 6C is an SEM image of failure surfaces after tensile tests of a FS STF-UFF composite. The arrow indicates the direction of the applied load during tensile testing, which was perpendicular to the failure surface.

FIG. 7 is a schematic depicting an exemplary method of impact testing.

FIGS. 8A-8F are cryo-SEM images of the FS18 composite, in order of increasing magnification.

FIG. 9 depicts exemplary composites of the disclosure undergoing long term exposure testing.

FIG. 10 is a schematic depicting an exemplary method of obtaining breakthrough pressure measurements.

FIG. 11 is a schematic depicting an exemplary method of impact testing.

FIGS. 12A-12F show the deformation of FS20 using a high-speed camera.

FIGS. 13A-13D depict the deformation as a function of time at various impact velocities for exemplary compositions of the disclosure. v₀ is the impact velocity of the rod when contact is first made with the sample.

FIGS. 14A-14C depict the distance between the surface of the STF and the bottom of the impact rod as a function of time.

FIG. 15A is a schematic of the Kelvin-Voigt model.

FIG. 15B is a schematic of the Maxwell model.

FIGS. 16A & 16B depict the maximum deformation due to impact and the energy dissipated by the materials.

FIG. 17 depicts rheology measurements of FS STFs. Viscosity vs. shear rate measurements for STF with fumed silica at between 15% and 20% loadings.

FIG. 18A shows the distance of penetration of drop object into STF during drop tests.

FIG. 18B shows the elastic modulus E and viscosity G from Kelvin-Voigt model for each STF.

FIG. 19A shows the breakthrough pressures of composites of fabrics with 224±35 nm fiber diameter and STFs having particle loadings of 0, 15, 18 and 20 wt % FS.

FIG. 19B shows the breakthrough pressures of composites of FS 20 with fabrics of different fiber diameters, as well as their corresponding median pore sizes determined by capillary porometry.

FIG. 20A shows a comparison of STF retention at room temperature over ˜200 days for composites with FS-15, FS-18, and FS-20.

FIG. 20B shows a comparison of STF retention between commercial microfiber fabric (MF) and electrospun mat (UFF) at 50° C. over 2 days.

FIGS. 21A-21C show the mechanical properties of UFF-STF composites with different nanoparticle loadings as compared to neat electrospun mats under tensile testing.

FIGS. 21D & 21E show the mechanical properties of UFF-STF composites with different nanoparticle loadings as compared to neat electrospun mats elasticity and viscosity from the Kelvin-Voigt model of the composites under impact testing.

FIGS. 22A-22C show the mechanical properties of UFF-STF composites with different fiber properties as compared to neat electrospun mats under tensile testing.

FIGS. 22D & 22E show the mechanical properties of UFF-STF composites with different fiber properties as compared to neat electrospun mats elasticity and viscosity from the Kelvin-Voigt model of the composites under impact testing.

FIG. 23 shows viscosity vs. shear rate measurements for STF with spherical silica nanoparticles (100-200 nm) between 50% and 65% particle loadings.

### DETAILED DESCRIPTION OF THE INVENTION

Fluid-impregnated fibrous materials have drawn attention in recent years because of their potential for improving the flexibility of mechanical protective clothing, such as body armor and other impact-resistant garments. Conventional materials used for body armor include metal and ceramics plates, as well as multi-ply fabrics, all of which tend to be heavy, rigid, and bulky. Not only can they be uncomfortable to wear, but they may also retard mobility and prolong response time. In addition, extremities, such as arms, legs, and hands, are not effectively protected by conventional body armors. As a result, ‘liquid body armor’, a type of composite comprising a fabric impregnated with an enhancing fluid, was proposed in the early 2000s to improve the flexibility and the wear comfort of protective clothing. Some of the earliest studies were conducted by Wagner and Wetzel using shear-thickening fluids (STFs), and by Deshmukh and McKinley using magnetorheological fluids. Thanks to the dependence of the viscosity of a STF on the rate of deformation, the STF-impregnated fabrics can remain flexible when the deformation rate is low. Upon impact or stab deformation, however, the viscosity of the STF increases due to the high strain rate and enhances the impact or stab resistance of the fabric, absorbing and dissipating energy. With the mechanical enhancement made possible by the STF, fewer fabric layers are needed to provide the same level of protection, thus reducing the bulkiness of the body armor and improving the flexibility and the comfort level.

STF is a type of non-Newtonian fluid whose rheological behavior transforms from liquid-like to solid-like when sheared above a threshold strain rate. STF generally consists of fine particles dispersed in a carrying liquid. Typical particles used in STFs include silica-based nanoparticles, latex, poly(methyl methacrylate) (PMMA), and even corn starch. Some common carrying liquids are polyethylene glycol (PEG), polypropylene glycol (PPE), and water. The shear-thickening behavior is characterized by an increase in viscosity at high strain rate. Based on the relative abruptness of the viscosity increase, shear-thickening can be categorized as either continuous or discontinuous. Discontinuous shear-thickening is characterized by a sudden divergence of stress as a function of shear rate, whereas the viscosity increase during continuous shear-thickening takes place gradually. The onset and the intensity of the shear-thickening behavior can be influenced by several parameters, including the shape and the surface chemistry of the dispersed particles, the particle concentration, the viscosity of the carrying liquid, and environmental factors such as humidity.

Several theories have been suggested to explain the mechanism of the shear-thickening phenomenon. A popular one is the hydrocluster formation theory, proposed by Wagner and Brady and observed microscopically by Cheng et al. This theory states that, under high shear rate, particles in the STF can form hydroclusters, a particle density fluctuation that arises as the relative motions of the particles become correlated at short distance. The high particle concentration in the hydroclusters results in higher stress of the fluid and an increase in viscosity. An earlier theory, suggested by Hoffman, hypothesizes that an order-disorder transition is the origin of the shear-thickening behavior. The increase in viscosity is attributed to the increased drag forces due to the disruption of particle arrangement from ordered layers into disordered structures at high shear rate. A third theory, based on the study by Brown and Jaeger, attributes the viscosity increase in STFs to dilatancy. That is, due to the expansion of the particle packing volume during shear, constraints from boundaries normal to the shear direction lead to increased frictional stress between particles. The phenomenon of discontinuous shear-thickening is captured by the dilatancy theory.

Commercial fabrics commonly used for mechanical protective clothing include woven microfiber fabrics of aramid fibers, such as Kevlar and Twaron, and ultrahigh-molecular weight polyethylene (UHMWPE) fibers, such as Dyneema and Spectra. ‘Liquid body armor’ composites fabricated by impregnating these fabrics with STF have been developed and characterized in past research. In one of the first studies by Lee, Wetzel, and Wagner, Kevlar fabrics treated with STF were shown to experience reduced deformation and to dissipate more energy in ballistic tests compared to neat fabrics, thereby decreasing the number of the fabric layers needed. Stab tests have also demonstrated that the fabric-STF composites suffered less damage compared to neat fabrics under the same impact. The proposed explanation of the enhancement is that the incorporation of STF reduces fiber movement, thus preventing ‘windowing’ (fibers being pushed aside by the stabbing object) in the fabrics and improving the impact resistance. This hypothesis is consistent with the results of yarn pull-out tests, which showed that higher loads were required to pull fibers out from STF-treated fabrics. Furthermore, the viscous STF is thought to disperse the impact energy over a larger area of the fabric, reducing the likelihood of fiber breakage.

Despite the improved mechanical performance of the STF-impregnated commercial fabrics, these composites can face a major challenge: the degradation of shape stability and the loss of the STF over time. Due to their large fiber size (>10 μm), the commercial fabrics generally contain large inter-fiber spaces, rendering it challenging for these fabrics to retain the STF stably over long periods of time because of the effects of gravity and evaporation. The treated fabrics were in fact sealed in a pouch in the Lee-Wetzel-Wagner study to prevent STF leakage.

Motivated by the STF retention limitation of conventional microfiber fabrics, the inventors improved the shape stability and the STF retention of fluid-impregnated fabrics by using electrospun ultrafine fiber (UFF) mats as the fabric component. Unlike commercial microfiber fabrics, UFF mats consist of nonwoven submicron fibers, resulting in high specific surface area and small interstitial spaces between fibers (also referred to as effective pore size). Due to the small pore size, once impregnated with STF, electrospun mats have the potential to improve the shape stability of the composites by holding the fluid phase in place with larger capillary forces. In this study, a type of UFF-STF composite was developed and evaluated for its shape stability and its mechanical properties under different deformation scenarios. Factors such as STF particle loading and UFF morphology were examined for their effects on the performance of the composite. The study aims to demonstrate in principle the application of electrospun UFF mats as a matrix for effective fluid retention, which can be useful in fabric-STF composites for protective clothing, as well as to provide insights for the development of solid-liquid composites using porous materials.

Disclosed herein are novel fabrics, comprising shear-thickening fluids (STFs) and polymer fibers for use in protective clothing, such as body armors. Desirable properties of the STFs include significant increase in viscosity at moderately high shear stress for impact resistance, as well as moderate viscosity at low shear stress to provide flexibility.

In one aspect, the present disclosure relates to a fabric comprising a plurality of polymer fibers and a shear-thickening fluid; wherein the polymer fibers have a diameter from 1-1,500 nm; the shear-thickening fluid comprises a plurality of nanoparticles or aggregates, and a suspending liquid.

In certain embodiments, the polymer fibers are ultrafine. In certain embodiments, the polymer fibers are nanofibers.

In certain embodiments, as the deformation rate of the fabric increases, the yield strength of the fabric increases. In certain embodiments, as the deformation rate of the fabric increases, the Young's modulus of the fabric increases. In certain embodiments, as the deformation rate of the fabric increases, the Young's modulus and the yield strength of the fabric increases.

In certain embodiments, the polymer fibers comprise a polyamide, a polyfin, a polyimide, a polyester, a polysaccharide, or a polypeptide. In certain embodiments, the polymer fibers comprise aramid. In certain embodiments, the polymer fibers comprise polyolefin. In certain embodiments, the fibers comprise wood fibers, plant fibers, or silk fibers. In certain embodiments, the polymer fibers comprise nylon or polyethylene. In certain embodiments, the polymer fibers comprise poly(trimethylhexamethylene terephthalamide. In certain embodiments, the polymer fibers consist of poly(trimethylhexamethylene terephthalamide. In certain embodiments, the polymer fibers comprise poly(hexamethylene adipamide. In certain embodiments, the polymer fibers consist of poly(hexamethylene adipamide). In certain embodiments, the polymer fibers comprise poly(p-phenylene terephthalamide). In certain embodiments, the polymer fibers consist of poly(p-phenylene terephthalamide). In certain embodiments, comprise poly(m-phenylene isophthalamide). In certain embodiments, consist of poly(m-phenylene isophthalamide). In certain embodiments, the polymer fibers comprise poly(ethylene). In certain embodiments, the polymer fibers consist of poly(ethylene). In certain embodiments, the poly(ethylene) is ultrahigh molecular weight.

In certain embodiments, the diameter of the polymer fibers is 1 nm-1,000 nm. In certain embodiments, the diameter of the polymer fibers is 240 nm-390 nm. In certain embodiments, the diameter of the polymer fibers is 510 nm-930 nm. In certain embodiments, the diameter of the polymer fibers is 100 nm-640 nm. In certain embodiments, the diameter of the polymer fibers is 270-600 nm. In certain embodiments, the diameter of the polymer fibers is 250 nm-610 nm.

In certain embodiments, the polymer fibers are prepared by wet spinning, dry spinning, melt spinning, extrusion spinning, direct spinning, gel spinning, electrospinning, drawing, electroblowing, centrifugal spinning, force spinning or nanospinning. In certain embodiments, the polymer fibers are prepared by electroblowing, centrifugal spinning, force spinning or nanospinning. In certain embodiments, the polymer fibers are prepared by electrospinning. In certain embodiments, the polymer fibers are prepared by methods equivalent to, related to, or derived from the aforementioned methods of preparing polymer fibers (e.g., wet spinning, electrospinning etc.).

In certain embodiments, the shear-thickening fluid comprises a plurality of nanoparticles. In certain embodiments, the nanoparticles comprise metal oxides, calcium carbonate, or cornstarch. In certain embodiments, nanoparticles are silica nanoparticles. In certain embodiments, the nanoparticles are 50 nm-500 nm in diameter. In certain embodiments, the nanoparticles are 100 nm-200 nm in diameter. In certain embodiments, the nanoparticles are 60 nm-70 nm in diameter. In certain embodiments, the nanoparticles are about 400 nm in diameter. In certain embodiments, the nanoparticles comprise 30%-70% by weight of the shear-thickening fluid. In certain embodiments, the nanoparticles comprise about 40% by weight of the shear-thickening fluid. In certain embodiments, the nanoparticles comprise about 35% by weight of the shear-thickening fluid. In certain embodiments, the nanoparticles comprise about 60% by weight of the shear-thickening fluid. In certain embodiments, the nanoparticles comprise about 65% by weight of the shear-thickening fluid. In certain embodiments, the nanoparticles comprise >60% by weight of the shear-thickening fluid.

In certain embodiments, the shear-thickening fluid comprises a plurality of aggregates. In certain embodiments, the aggregates are fumed silica. In certain embodiments, the aggregates are 50 nm-500 nm in diameter. In certain embodiments, the aggregates are 200 nm-300 nm in diameter. In certain embodiments, the aggregates comprise 5%-20% by weight of the shear-thickening fluid. In certain embodiments, the aggregates comprise >15% by weight of the shear-thickening fluid. In certain embodiments, the aggregates comprise about 15% by weight of the shear-thickening fluid. In certain embodiments, the aggregates comprise about 18% by weight of the shear-thickening fluid. In certain embodiments, the aggregates comprise about 20% by weight of the shear-thickening fluid.

In certain embodiments, the suspending liquid is an alcohol. In certain embodiments, the suspending liquid is a glycol. In certain embodiments, the suspending liquid is a polyglycol. In certain embodiments, the suspending liquid is polyethyleneglycol or polypropylene glycol. In certain embodiments, the suspending liquid is polyethyleneglycol-200 or polyethyleneglycol-400. In certain embodiments, the suspending liquid is polypropylene glycol. In certain embodiments, the suspending liquid is water.

In certain embodiments, the shear-thickening fluid is impregnated between the polymeric fibers. In certain embodiments, the shear-thickening fluid is impregnated among polymeric fibers.

In certain embodiments, the thickness of the fabric is 1 μm-10 mm. In certain embodiments, the thickness of the fabric is 1 μm-1,000 μm. In certain embodiments, the thickness of the fabric is 50 μm-500 μm. In certain embodiments, the thickness of the fabric is 50 μm-100 μm. In certain embodiments, the thickness of the fabric is 100 μm-200 μm. In certain embodiments, the thickness of the fabric is 100 μm-150 μm.

In certain embodiments, the Young's Modulus of the fabric is 1 MPa-100 GPa. In certain embodiments, the Young's Modulus of the fabric is 1 MPa-50 GPa. In certain embodiments, the Young's Modulus of the fabric is 1 MPa-25 GPa. In certain embodiments, the Young's Modulus of the fabric is 1-100 MPa. In certain embodiments, the Young's Modulus of the fabric is 1-30 MPa.

In certain embodiments, the maximum stress of the fabric is 0.5 MPa-10 GPa. In certain embodiments, the maximum stress of the fabric is 0.5 MPa-7.5 GPa. In certain embodiments, the maximum stress of the fabric is 0.5 MPa-5.0 GPa. In certain embodiments, the maximum stress of the fabric is 0.5 MPa-2.5 GPa. In certain embodiments, the maximum stress of the fabric is 0.5-6.0 MPa. In certain embodiments, the maximum stress of the fabric is 0.7-1.3 MPa.

In another aspect, the present disclosure relates to an article of clothing comprising the fabric disclosed herein. In certain embodiments, the article of clothing is a protective article of clothing. In certain embodiments, the article of clothing is body armor. In certain embodiments, the article of clothing is sports apparel (e.g., kneepads, shoulder pads, a helmet, or shin guards).

In yet another aspect, the present disclosure relates to a method of making the fabric of the disclosure comprising the steps of:

contacting the shear-thickening fluid with an alcohol thereby forming a solution;

contacting the solution with the plurality of polymeric fibers; and

removing the alcohol, thereby forming the fabric.

In certain embodiments, the alcohol is methanol, ethanol, or propanol (e.g., isopropanol).

In certain embodiments, the alcohol is removed by evaporation.

In yet another aspect, the present disclosure relates to a method of making the fabric of the disclosure, comprising the steps of:

i) contacting the shear-thickening fluid with an alcohol thereby forming a solution;

ii) contacting the solution with the plurality of polymeric fibers; and

iii) removing the alcohol, thereby forming the fabric.

In certain embodiments, the alcohol is methanol, ethanol, or propanol (e.g., isopropanol).

In certain embodiments, the alcohol is removed by evaporation.

### Definitions

Unless otherwise defined herein, scientific and technical terms used in this application shall have the meanings that are commonly understood by those of ordinary skill in the art. Generally, nomenclature used in connection with, and techniques of, chemistry, engineering, rheology, and mechanics, described herein, are those well-known and commonly used in the art.

Chemistry terms used herein, unless otherwise defined herein, are used according to conventional usage in the art, as exemplified by “The McGraw-Hill Dictionary of Chemical Terms”, Parker S., Ed., McGraw-Hill, San Francisco, Calif., U.S.A., (1985).

Engineering terms used herein, unless otherwise defined herein, are used according to conventional usage in the art, as exemplified by “The McGraw-Hill Dictionary of Engineering (Second Edition)”, McGraw-Hill, New York, N.Y., U.S.A., (2003).

Mechanical terms relating to rheology as used herein, unless otherwise defined herein, are used according to conventional usage in the art, as exemplified by “Rheology: Concepts, Methods, and Applications (Third Edition)”, Malkin, A., Isayev, A., ChemTec Publishing, Scarborough, O.N., Canada, (2017).

All of the above, and any other publications, patents and published patent applications referred to in this application are specifically incorporated by reference herein. In case of conflict, the present specification, including its specific definitions, will control.

### EXAMPLES

The invention now being generally described, it will be more readily understood by reference to the following examples, which are included merely for purposes of illustration of certain aspects and embodiments of the present invention, and are not intended to limit the invention.

### Example 1: Preparation of Exemplary Shear Thickening Fluids

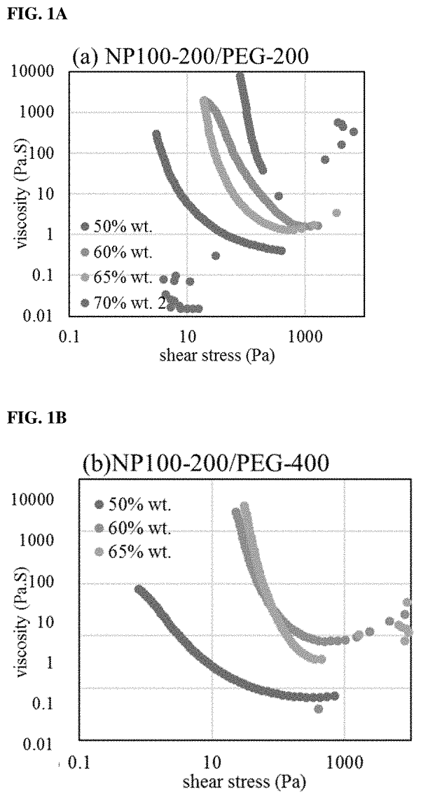

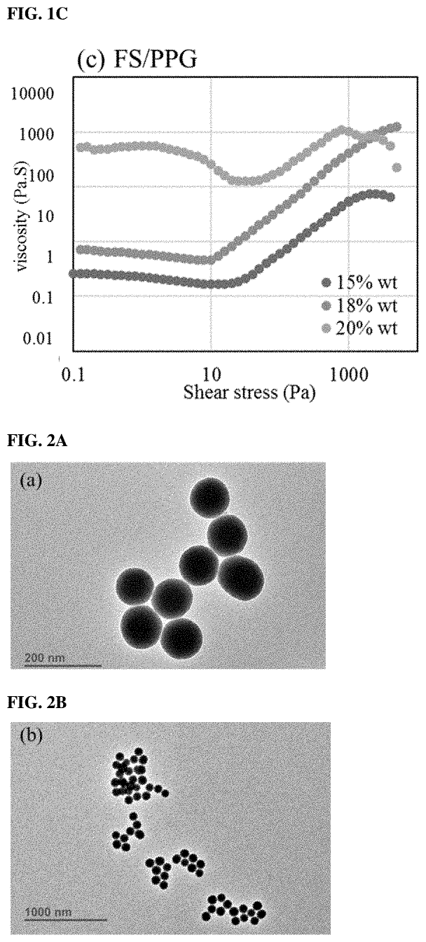

Several nanoparticles were explored for the STF, including fumed silica nanoparticles (FS, CAS 112945-52-5, nominal aggregate size 200-300 nm, surface area 200±25 m²/g, Sigma-Aldrich) and individual silica nanoparticles (NP, CAS 7631-86-9, 100-200 nm: KE-P10, SEAHOSTAR; 60-70 nm and 400 nm: US Research Nanomaterials, Inc). The geometries of the spherical and fumed silica nanoparticles are shown in FIG. 1. The carrying liquids used were polypropylene glycol (PPG, CAS 25322-69-4, MW=725, Sigma-Aldrich) and polyethylene glycol of two molecular weights (PEG, CAS 25322-68-3, MW=200, TCI; MW=400, Sigma-Aldrich). The nanoparticles were dispersed in the carrying liquid by sonication using an ultrasonic tip homogenizer (Ultrasonic Processor, Cole-Parmer) at 750 watt and 20 kHz for a minimum of 1 hour, or until the dispersion was homogeneous. To aid the dispersion, ethanol (CAS 64-17-5, Sigma-Aldrich) was added to the STF at a volume ratio of 2:1 (ethanol:STF) during mixing. After sonication, the dispersion was heated in a water bath at 60° C. for a minimum of 24 hours to evaporate the ethanol. The rheological measurements were conducted on a shear rheometer (AR-2000, TA Instruments) at room temperature using a cone-plate geometry with 2° cone angle, 52 μm truncation, and 20 mm diameter. The main STF used consisted of FS nanoparticles dispersed in PPG, with three particle loadings (by weight) of 15%, 18%, and 20%, which are abbreviated as FS-15, FS-18, and FS-20.

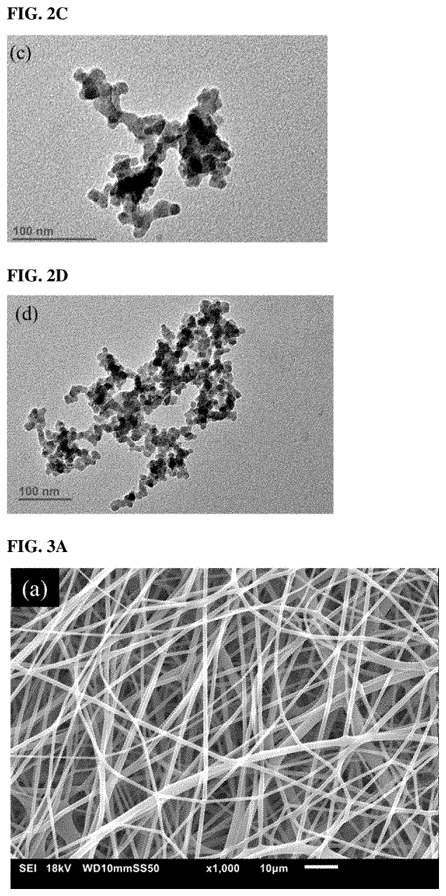

Several STFs of different particle-liquid combinations were formulated and characterized. The results are summarized in Table 1. NP100-200 is the most promising choice among the NP/PEG systems for formulating STFs due to ease of mixing and observation of shear-thickening behavior. FS/PPG exhibits more dramatic shear-thickening behavior at lower loading, so it was also chosen for further testing. The rheological measurements of three such sets of materials are shown in FIGS. 1A-1C. Representative TEM images are shown in FIGS. 2A-2D.

TABLE 1
Characterization of STFs

| Particle | NP60-70 | NP400 | NP100-200 | NP100-200 | FS200-300 |
|---|---|---|---|---|---|
| Liquid | PEG-200 | PEG-200 | PEG-200 | PEG-400 | PPG |
| Loading limit (wt. %) | ~40 | >60 | ~70 | ~70 | >20 |
| ST loading* (wt. %) | 35 | >60 | 65 | 60 | <15 |
| ST shear stress* (Pa) | ~300 | NA | ~500 | ~400 | ~20 |
| ST shear rate* (1/s) | ~100 | NA | ~500 | ~100 | ~10 |
| ST viscosity* (Pa · s) | ~2.9 | NA | ~1.2 | ~8 | ~2 |

*refers to loading, shear stress, shear rate, and viscosity above which shear-thickening behavior was observed

### Example 2: Preparation of Exemplary Ultrafine Fibers

Electrospun membranes of two nylon materials, poly(trimethylhexamethylene terephthalamide (PA6(3)T) and poly(hexamethylene adipamide) (PA6,6), were produced and tested. Since the particles in the STFs could be up to a few hundred nanometers in diameter, and the spaces between fibers are known to correlate with fiber diameter, fibers of relatively large diameters (yet still ultrafine) were desired to facilitate the impregnation of STFs into the membranes.

The precursor solutions were made by dissolving poly(hexamethylene adipamide) pellets (PA 6,6, CAS 32131-17-2, Scientific Polymer Products, Inc.) in a mixture of formic acid (FA, CAS 64-18-6, Sigma-Aldrich) and dichloromethane (DCM, CAS 75-09-2, Sigma-Aldrich) at a weight ratio of 3:2 (FA:DCM). Precursors of two polymer weight concentrations, 12% and 15%, were used to produce mats of different fiber sizes (abbreviated as PA12 and PA15). The UFF mats were spun in a commercial electrospinning system (NanoSpinner NS24, Inovenso) onto a drum collector 10 cm in diameter rotating at 100 rpm. The nominal electric field strength was 3 kV/cm, using an applied voltage of 30 kV with a needle-collector distance of 10 cm. The precursor was fed through a 15 G needle at a flow rate between 0.6 and 0.8 mL/hr. The relative humidity was 21%. Some electrospun mats were heated on a hot press at 180° C. for one hour to investigate the effect of annealing.

The fiber morphology and diameter were characterized using scanning electron microscopy (SEM, JEOL 6010A, JEOL, Ltd.). A micrometer (Mitutoyo 293-832, Mitutoyo Corp.) with 0.5 N of applied force was used to measure the thicknesses of the electrospun mats. A capillary porometer (POROLUX 1000, Porometer) was used to measure the effective pore size of the membranes, with perfluoroether (Porefil, Porometer) as the wetting fluid. The median pore size (dₘ) was calculated using the Young-Laplace equation for capillary pressure in a tube (Eq. 1),¹⁸ where the corresponding pressure (Pₘ) was determined as the intersection of the half dry curve and the wet curve on the flow vs. pressure diagram. Since there is no well-defined pore shape for the inter-fiber spaces in nonwoven materials, a shape factor (S) of 0.715 was used in the effective pore size calculation per the ASTM-F316-86 method. γ is the surface tension of the liquid and θ is the intrinsic contact angle of the liquid on a smooth surface of PA 6,6:

$${d}_{m} = \frac{4 S γ cos θ}{{P}_{m}} \qquad Eq . 1$$

Table 2 and Table 3 summarize several spinning conditions and corresponding resultant fiber sizes of the two nylon materials thus produced.

Due to the high stability of nylon 6,6, it is not readily soluble in common organic solvents. As a result, formic acid (FA) was used to formulate the polymer precursor for electrospinning. Because of its high acidity, conductivity, and volatility, pure FA solution dries overly fast during electrospinning, and the high level of ion repulsion at the needle sometimes leads to unstable spinning. In order to achieve stable electrospinning to produce large enough membranes with reasonable thickness, a screening study of solvent combinations and spinning conditions was conducted, the result of which is summarized in Table A-2. It was found that the solvent combination of FA and DCM at weight ratio of 3:2 (FA:DCM) yielded the most stable spinning. This solvent mixture was used for the fabrication of the electrospun membranes in the rest of the study.

TABLE 2
Electrospinning conditions of PA6(3)T membranes

| | | | Needle-plate | Flow | Fiber | |
|---|---|---|---|---|---|---|
| Conc. | | Potential | distance | rate | diameter | |
| (wt. % ) | Solvent | (kV) | (cm) | (mL/hr) | (nm) | Spinnability |
| 25 | DMF + 1% FA | 39 | 15 | 0.5 | 311.93 ± 68.85 | spinnable |
| 30 | DMF + 1% FA | 35 | 11 | 0.3 | 787.76 ± 348.44 | spinnable |

TABLE 3A
Electrospinning conditions of PA6.6 membranes

| | | | Needle- | | | |
|---|---|---|---|---|---|---|
| | | | plate | Flow | Fiber | |
| Conc. | | Potential | distance | rate | diameter | |
| (wt. % ) | Solvent | (kV) | (cm) | (mL/hr) | (nm) | Spinnability |
| 25 | FA | 33 | 13 | 0.9 | 719.60 ± | Unstable |
| | | | | | 210.06 | |
| 20 | FA + DMF | 30 | 12 | 0.5 | 368.86 ± | Unstable |
| | (15:1) | | | | 265.23 | |
| 15 | FA + DCM | 32 | 11 | 0.5 | 436.57 ± | spinnable |
| | (3:2) | | | | 164.28 | |
| 20 | FA + DCM | 30 | 12 | 0.5 | 429.92 ± | spinnable |
| | (3:2) | | | | 176.71 | |

To produce consistent and replicable membranes from different spinning runs, a study of electrospinning conditions was conducted to understand the effect of parameters such as humidity and the strength of the electric field (by varying the needle-collector distance at constant voltage) on the fiber morphology, the results of which are shown in Table 3B. Two polymer concentrations, 12% and 15%, were examined, and were found to exhibit significantly different fiber morphologies from each other. The 12% solution yielded smooth fibers with relatively uniform diameter within the voltage and humidity ranges investigated. The fiber diameters of 12% membranes were generally below 300 nm. The fiber size of 15% membranes, on the other hand, showed large variation depending on the spinning conditions. With increasing electric field strength, the fiber diameters of membranes from both solutions decreased in general. This trend was also observed in the literature for Nylon 6 above 1.5 kV/cm.²⁷ A likely explanation is that the stronger electric field increased the induced charge, which led to stronger electrostatic repulsion during jet formation and therefore thinner jets. In the case of the 15% precursor solution, the morphology of the fibers also changed with electric field. Flat fibers were observed for membranes from 2.5 and 3 kV/cm under low humidity, resulting in high polydispersity. Nonetheless, as the electric field increased and led to further jet thinning, the fibers became thinner and cylindrical in shape. In addition, the study demonstrated that humidity was another factor that could significantly influence fiber morphology. With the electric field fixed at 3 kV/cm, the two polymer solutions were spun under different relative humidities (RH). Interestingly, the higher the humidity, the more stable the spinning was, and the smaller the fibers were. Although, RH has been found to influence different solution systems differently, a similar trend was observed for Nylon 6. The fiber thinning at higher humidity might have been due to a decrease in solution flow rate that accompanied stabilization of the jet at higher humidity. Stabilization of the jet and improvements in fiber smoothness and uniformity of the 15% membranes at high RH is believed to have been a consequence of an increase in the ratio of evaporation rate of the main solvent, formic acid, relative to the solution flow rate. The reason for flat fiber formation was buckling of the outer shell due to a mismatch of the drying rates of the skin and the core. Therefore, faster evaporation of the solvent at higher RH allowed the fibers to dry fully during the whipping motion before reaching the collector. As a result of such effects, membrane properties could exhibit day-to-day variations depending on the weather. This behavior highlights the importance of environmental control during large-scale electro spinning operations.

TABLE 3B
Effect of electrospinning conditions on PA 6,6 fiber diameter.

| Electric Field | Relative | Fiber Diameter (nm): | Fiber Diameter (nm): |
|---|---|---|---|
| (kV/cm) | Humidity | 12% polymer concentration | 15% polymer concentration |
| 2.5 | 7-8% | 290 ± 77 | 955 ± 644 (some flat fibers) |
| 3 | 7-8% | 289 ± 73 | 558 ± 136 (some flat fibers) |
| 3 | 14% | 218 ± 73 | 439 ± 140 (some flat fibers) |
| 3 | 21% | 224 ± 35 | 477 ± 250 |
| 3 | >25% | 196 ± 47 | 401 ± 101 |
| 3.5 | 7-8% | 249 ± 40 | 360 ± 77 |

### Example 3: Preparation of Exemplary Composites

Due to the high particle loading within the STFs, and to facilitate the penetration of the STFs into the membrane, the STFs were diluted with ethanol in a ratio of 2:1 (by weight) for composite fabrication. The mixtures were then transferred onto the as-spun membranes until the entire membrane was submerged in the mixture (for a 4 cm×4 cm membrane, 4 g of mixture was used). The samples were left to dry overnight to allow the ethanol to evaporate. The resultant composites weighed roughly 10× the original weight of the membranes. After this treatment, the composites could be easily peeled off from the petri dishes with a tweezer. The membranes comprising lower loading of STFs appeared wet, but composites made of 18 and 20 wt % FS STFs looked more ‘solid-like’ and similar to regular fabrics. No wetting issues were observed in the impregnation process, as both ethanol and PEG/PPG readily wet the PA6,6 membranes.

### Example 4: Exemplary Characterization of Composites

### Preliminary Shape—Stability Testing

The shape stability of the composite was characterized using a breakthrough pressure measurement. Although typically applied in pore size estimation, the breakthrough pressure is in fact a direct measurement of the capillary force in a wetted porous structure, which is suitable for evaluating the fluid retention stability of the UFF-STF composites. The capillary porometer was used to measure the maximum pressure drop across the composite at the bubble point, where STF is first evacuated from the largest pores of the mats. A breakthrough flow of 3 mL/min was used for the 4.9 cm² samples to determine the breakthrough pressure.

The STF retention was evaluated by exposing the composites to 1) suspending the sheet-like composites vertically in the ambient environment over a long period of time and 2) storing in an oven at elevated temperature. During the former, the composite was hung from a line in the ambient environment at room temperature (20 to 25° C.) and relative humidity between 10% and 30% for 198 days, during which time the STF could be lost from the composite through evaporation and/or dripping under the action of gravity. To evaluate STF retention at higher temperature, the composites were placed in an environmental chamber at 50° C. with a relative humidity between 30% and 40% for 48 hours. For comparison, a woven commercial nylon microfiber fabric with a fiber diameter of approximately 20 μm was similarly treated with STF to form composites, which were then tested under the same conditions. The loss of the STF was measured gravimetrically.

For example, four samples were hung vertically on a piece of string for 3 weeks. No change in the shape of the composites nor dripping of STFs was observed. The observation is consistent with the hypothesis that capillary forces and the large specific surface area of (UFF) membranes helps keep the STFs in the fabric.

### Tensile Testing

Several sets of tensile tests were performed to evaluate the mechanical properties of the composites when stretched in the plane of the fibers. Three properties were calculated for each sample: Young's modulus, maximum stress, and strain-at-break.

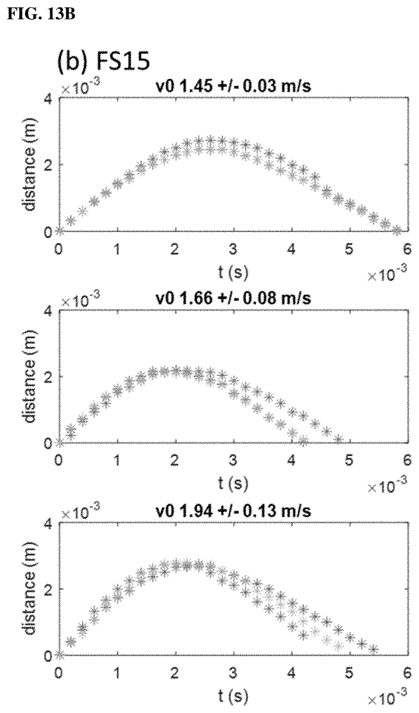

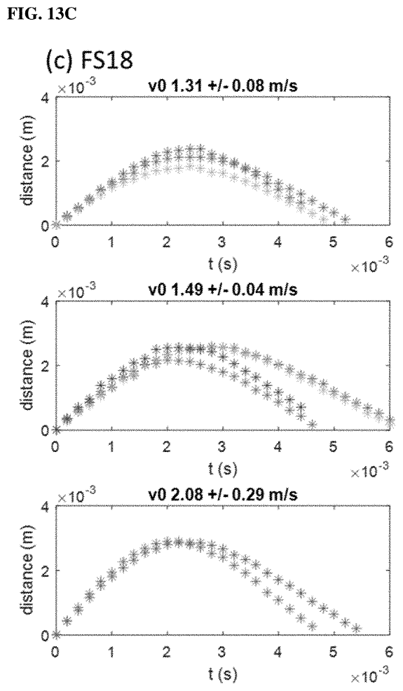

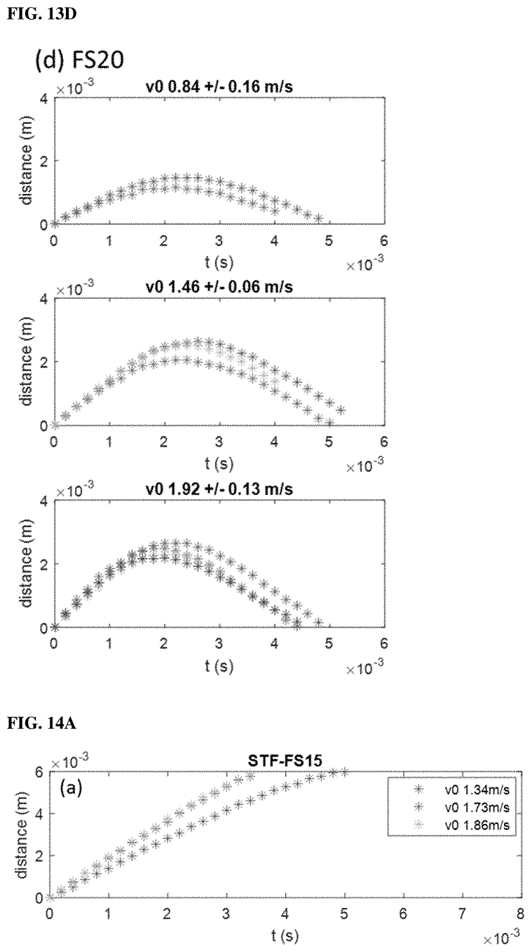

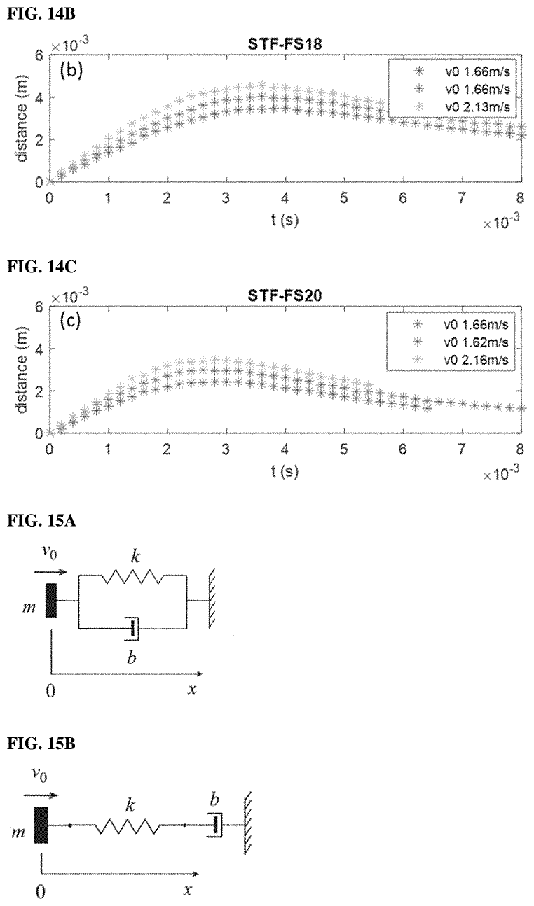

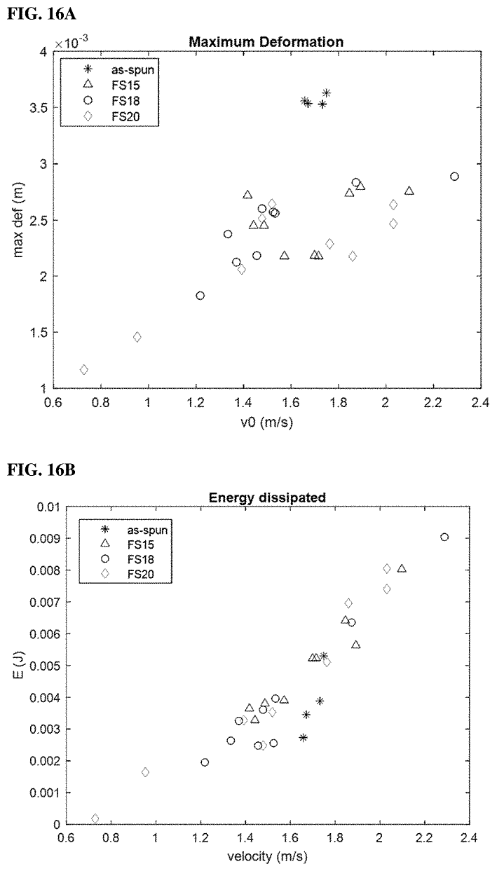

The dimension of all samples was 1 cm×3 cm. The deformation rate was kept was 100 mm/min, or a strain rate of 0.167 s⁻¹. Two sets of tests are shown in Table 4 and Table 5. In the first set, UFF membranes made from 15% PA6,6 (PA66-15) with an average thickness of 77.7±9.3 μm and impregnated with two types of STFs (65% NP100-200 in PEG and 15% FS in PPG, henceforth denoted NP-65/PEG and FS-15/PPG, respectively) as well as with the pure liquid phases (PEG400 and PPG) were tested and compared with the as-spun (unimpregnated) case. The representative strain-stress curves of the first set of tests are shown in FIGS. 13A-13D. Incorporation of STFs or liquids into the membrane did not affect the initial response (region 1); both the Youngs' modulus and range of strain over which the initial response persisted (up to about 10% strain) were similar for all samples tested. However, the samples impregnated with the pure liquids subsequently exhibited a much softer deformation response up to about 50-150% strain (region 2) compared to those impregnated with STF or nothing at all, likely due to a lubrication effect. Impregnation with either the pure liquids or with the NP-based STF decreased the maximum stress observed in region 2 relative to the as-spun membrane, whereas impregnation with the FS-based STF appeared comparable to the as-spun membrane. Despite its higher solids content, the NP-65/PEG composite felt tackier than the FS-15/PPG composite, so it is possible that the NP-based STF also lubricated the fibers, allowing them to move more easily. For all STF- or liquid-filled samples, the maximum strain-at-break was increased relative to that of the as-spun membranes, also potentially due to the movement of the fibers. SEM images of the failure surfaces after testing are shown in FIGS. 14A-14C. The as-spun membrane exhibited a sharp and uniform edge at the break, indicative of brittle fracture. Both NP-65/PEG and FS-15/PPG, however, showed considerable plastic deformation at the ends and formed ‘tails’ at the break points, which further suggests that fiber movement occurred.

The second set of tensile tests focused on the FS-based STFs of different particle loadings, as the previous tests suggested that FS-15/PPG outperformed NP-65/PEG. Thicker membranes (average thickness of 125.2±22.5 μm) were used in this set of tests; for this reason, the membranes appeared stronger than the first set. As illustrated in Table 5, none of the FS-based STFs significantly influenced tensile mechanical performances of the membrane composites. However, it may be noted that the deformation rate of these tests was in all cases below the deformation rate at which the shear-thickening occurs, due to instrument limitations. As a result, the STFs were not expected to change significantly in viscosity or contribute to mechanical strength under these conditions. Nonetheless, the tensile tests provide valuable insights into the effects of STFs on the composites at low shear rate.

TABLE 4
Tensile tests of STF-UFF composites and liquid-treated membranes

| | As-spun | NP-65/PEG | FS-15/PPG | PEG | PPG |
|---|---|---|---|---|---|
| Young’s | 14.18 ± | 12.80 ± | 15.73 ± | 9.86 ± | 9.26 ± |
| Modulus | 6.54 | 3.54 | 12.45 | 4.03 | 6.78 |
| (MPa) | | | | | |
| Max Stress | 2.47 ± | 0.99 ± | 2.23 ± | 1.10 ± | 1.15 ± |
| (MPa) | 0.84 | 0.26 | 1.05 | 0.38 | 0.70 |
| Strain-at- | 0.58 ± | 0.83 ± | 0.97 ± | 0.74 ± | 0.85 ± |
| break | 0.12 | 0.35 | 0.11 | 0.25 | 0.12 |

TABLE 5
Tensile tests of STF-UFF composites made of FS STFs

| | As-spun | FS-15/PPG | FS-18/PPG | FS-20/PPG |
|---|---|---|---|---|
| Young’s | 51.39 ± 20.85 | 59.11 ± 26.69 | 58.91 ± 15.87 | 60.52 ± 15.87 |
| Modulus | | | | |
| (MPa) | | | | |
| Max Stress | 3.74 ± 0.82 | 4.30 ± 1.62 | 4.14 ± 0.90 | 3.84 ± 1.56 |
| (MPa) | | | | |
| Strain-at- | 0.24 ± 0.05 | 0.25 ± 0.14 | 0.30 ± 0.05 | 0.20 ± 0.07 |
| break | | | | |

### Example 5: Further Characterization of Composites

### Long-Term Exposure Test

The composites were exposed in the ambient lab environment (temperature 20° C.-25° C., relative humidity 10%-30%) for 28 weeks. As shown in FIG. 9, the composites exhibited no visible deformation. No dripping of the STF was observed for any of the samples.

In addition, the same amounts of the STFs were incorporated into commercial nylon fabrics for comparison with the electrospun membranes. The mass ratios of STF to electrospun membrane and STF to commercial fabrics are 14 and 1.6, respectively. The composites were weighed before and after the 28-week period. Table 7 summarizes the change in weight for both types of composites. Comparison between the electrospun and commercial samples shows that electrospun membranes are significantly better at retaining the STFs over a long period of time. Moreover, the higher the particle loading of the STF, the smaller the weight loss was. In the cases of electrospun samples FS18 and FS20, the change in mass was rather marginal, and could be due to evaporation of residual ethanol. This test suggests that electrospun membranes can hold a larger amount of STFs per unit weight compared to commercial fabrics while maintaining shape stability. Nonetheless, the evaporation of liquid needs to be accounted for when applying the materials in final applications. For example, an impermeable layer could be used to coat the composite.

TABLE 7
Percentage change in weight of composite fabrics over a
period of 28 weeks

| | | |
|---|---|---|
| FS15 | FS18 | FS20 |

Electrospun

| | | | |
|---|---|---|---|
| Mass of membrane (g) | 0.05 | 0.06 | 0.05 |
| Mass w/ STF, t = 0 week (g) | 0.69 | 0.76 | 0.79 |
| Mass w/ STF, t = 28 week (g) | 0.58 | 0.72 | 0.76 |
| Change | −17% | −6% | −4% |

Commercial

| | | | |
|---|---|---|---|
| Mass of membrane (g) | 0.55 | 0.57 | 0.54 |
| Mass w/ STF, t = 0 week (g) | 0.94 | 0.81 | 0.88 |
| Mass w/ STF, t = 28 week (g) | 0.85 | 0.78 | 0.82 |
| Change | −23% | −13% | −18% |

### Breakthrough Pressure Test

Breakthrough pressure measurements were used to quantify the stability of the STFs in the electrospun membranes. The maximum pressure difference that the composite can withstand indicates the stress required to drive the STF out of the membrane against the capillary forces holding them in place. FIG. 10 demonstrates the setup of the measurements, in which one side of the composite is slowly pressurized by a gas while the pressure drop across the sample is monitored. When the pressure drop across the membrane exceeds the minimum capillary force (i.e., that required to extrude the STF from the largest diameter channel in the composite), gas begins to flow through the membrane, reducing the pressure drop. The breakthrough pressure refers to the maximum pressure in this case.

The results of the breakthrough pressure measurements, averaged over 3 to 5 trials, are tabulated in Table 8. The breakthrough pressures of all three composites were greater than 2 atm, indicating strong stability of the STFs in the membranes. There were no significant differences between the breakthrough pressures of composites containing different particle loadings.

TABLE 8
Breakthrough pressures of the composites

| | FS15 | FS18 | FS20 |
|---|---|---|---|
| Breakthrough P (kPa) | 229.39 ± 55.43 | 216.91 ± 103.42 | 279.51 ± 6.69 |

*It was not possible to measure the breakthrough pressure of the commercial nylon composites because the commercial fabric was too thick and dense, so that even the pressure drop of the fabric itself exceeded the range of measurement.

### Impact Test—High Deformation Rate

Drop tests were used to characterize viscoelastic response under impact at high deformation rate. A sample disc 4 cm in diameter was clamped down with metal screws onto a ring-shaped sample holder with an inner diameter of 2.5 cm. A 60° section of the ring was removed so that the onset of impact and the sample deformation could be observed with a camera from the side without obstruction. A nylon rod 3.175 mm in diameter and 2.83 g in weight was used as the drop object; this rod was chosen for its small diameter in comparison to the sample size and its moderate weight to avoid breaking of the samples. The object was released onto the sample from a height of approximately 30 cm above the sample, resulting in an impact velocity between 1.5 and 2.5 m/s, which corresponded to an average deformation rate between 100 and 150 s⁻¹. A guiding tube was used so that the rod would remain upright during the drop and impact the membrane sample vertically. A high-speed camera (Phantom V2512, AMETEK) was used to record the deformation of the composite at a frame rate of 5000 fps.

The trajectory of the impact rod was extracted from the videos in MATLAB to obtain the impact velocity and the sample deformation. A black sticker was placed on the white impact rod. During image processing, the edge of the sticker was tracked, yielding the relative position of the rod as a function of time, which corresponded to the displacement, z, of the center of the membrane after contact. The impact velocity (v₀) was determined using the distance traveled by the rod during the 3 frames (0.6 ms) before contacting the membrane.

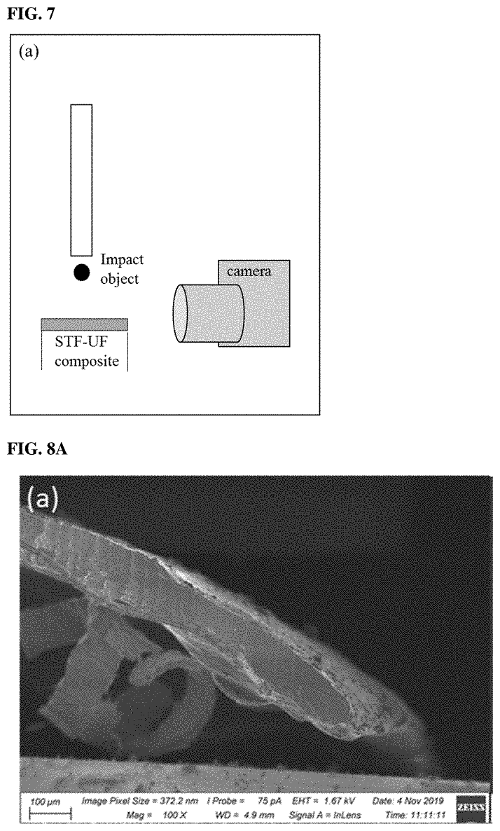

Tables 9 and 10 summarize the testing conditions and the sample properties. FIG. 7 illustrates the drop test setup.

TABLE 9
Testing conditions of the drop tests

| | |
|---|---|
| Sample diameter (mm) | 25 |
| Impact rod diameter (mm) | 3.175 |
| Impact rod weight (g) | 2.83 |
| Drop height (cm) | 13-30 |
| Frame rate (fps) | 5000 |
| Exposure time (μs) | 199 |

TABLE 10
Sample properties

| Sample | Thickness (μm)* | Basis Mass (g/m²S) |
|---|---|---|
| As-spun | 141 ± 18 | 19.93 ± 1.48 |
| FS15 | 130 ± 36 | 328.04 ± 60.05 |
| FS18 | 136 ± 36 | 236.96 ± 33.47 |
| FS20 | 124 ± 21 | 233.43 ± 29.51 |

*The thickness was measured with a micrometer under a force of 0.1N.

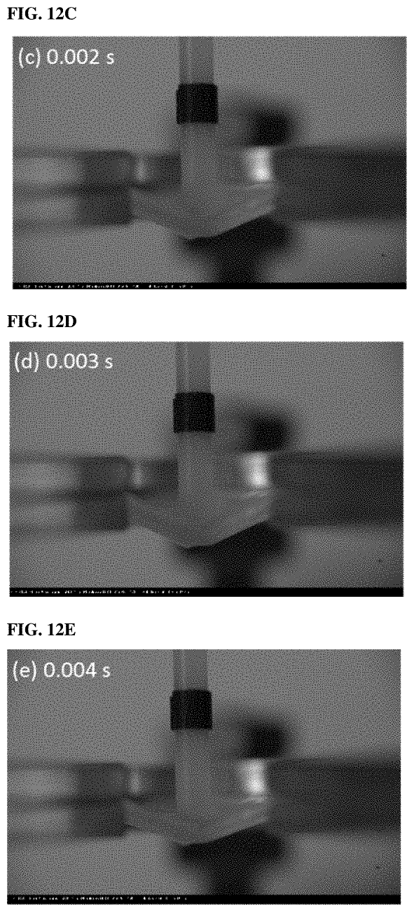

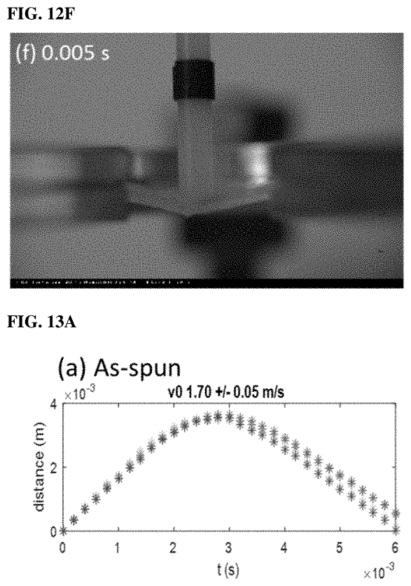

FIGS. 12A-12F show illustrative examples of the response of the FS20 sample to impact, captured by the high-speed camera, at intervals of 0.001 s. No samples were penetrated under the testing conditions reported here. The camera monitored sample deformation from the moment of impact until the rod separated from the sample.

In addition to the composites, the drop tests were also performed on the three STFs from the same range of drop heights. FIGS. 13A-13D show the deformation versus time for the as-spun membranes and their composites with STFs, while FIGS. 14A-14C show deformation versus time for the STFs alone. For membranes and composites, deformation refers to the distance deformed in the direction of the impact. For STFs, deformation refers to the distance between the bottom of the rod and the surface of the fluid.

A comparison of the responses of the as-spun membranes with those of the composites shows that incorporating the STFs into the membrane reduced the maximum deformation upon impact significantly. The higher the impact velocity, the larger the resultant deformation was. Examination of the bottom row in FIGS. 13A-13D show that, at similarly high impact velocities, F20, the composite containing the highest particle loading, suffered the smallest deformation and recovered from the deformation most quickly, indicating a more elastic behavior than F15 and F18.

Significant differences were observed across the responses of the three STFs. The impact rod sank into the FS15 STF, but rebounded in the cases of F18 and F20. The penetration into the fluid was the smallest for FS20, suggesting the strongest impact resistance.

The Kelvin-Voigt model, which is frequently used to describe creep under constant applied stress in viscoelastic materials, was employed to model the viscoelastic behavior of the membrane samples during the impact tests, since the membranes were under tension at all times due to the force of gravity acting on the drop object. At each time step, the following equations were used to calculate the stress on the membranes and the acceleration of the drop object.

$$\begin{matrix}R = {( {R}_{0}^{2} + {z}^{2} )}^{1 \text{/} 2} & Eq . 2 \\ ɛ = \frac{R}{{R}_{0}} - 1 & Eq . 3 \\ σ = E ɛ + G \frac{\partial ɛ}{\partial t} & Eq . 4 \\ {F}_{z} = 2 π {R}_{0} H σ \frac{z}{R} & Eq . 5 \\ \frac{{\partial }^{2} z}{\partial {t}^{2}} = \frac{{F}_{z}}{m} - g & Eq . 6\end{matrix}$$

The initial conditions at t=0 were as follows: ε(t=0)=0, σ(t=0)=0, z(t=0)=0, and R is the radius of the membrane during deformation, and R₀ is the initial radius. z represents the deformation of the membrane in the impact (axial) direction. ε is the strain while σ is the stress, both parallel to the deformed sample radius, R. E represents the elasticity and G represents the viscosity. F_{z} is the force exerted by the membrane on the drop object of mass m in the z direction. H is membrane thickness and g is the gravitational acceleration.

The MATLAB ode45 function was used to integrate the equations (2) through (6) over time to calculate the z vs. time trajectory for a given E and G combination. The viscoelastic properties of a sample were determined by finding the E and G combination that yielded the least-squared difference between the experimental and calculated trajectories.

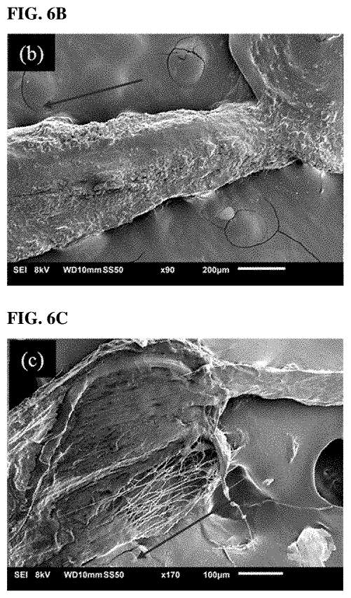

FIGS. 16A & 16B show a plots of the maximum deformation due to impaction and the energy dissipated in each sample. Consistent with the results of FIG. 6, the as-spun membranes exhibited larger deformation, indicating the enhancement of impact resistance due to STFs in the composites. The energy dissipated was calculated by comparing the impact and exit velocities of the rod to obtain the loss in the kinetic energy. FIG. 16B shows that the dissipated energy increases with impact velocity, which is consistent with the rate of energy dissipation being proportional to rate of strain in a viscous fluid.

In addition, a similar impact test was conducted on bulk STFs to probe STF responses separately under the relevant conditions of the impact tests for composites. The drop object and the drop height were the same as those used in the membrane impact tests, but the test sample was approximately 30 mL of STF in a beaker 4.5 cm in diameter; the fluid depth was about 2 cm. The average impact velocity was 1.76±0.26 m/s, corresponding to an impact strain rate of around 1100 s⁻¹. The trajectory of the drop object was tracked similarly using the high-speed video camera, and the viscosity and the elasticity were calculated by fitting to the Kelvin-Voigt model. Without the circular membrane geometry in this case, the strain ε of the bulk STF is linearly proportional to z, as shown in Eq. 7, where R_{drop} is the radius of the drop object. The force in the z direction that was previously calculated in Eq. 5 could be obtained with Eq. 8. Then Eq. 6 could be solved analytically, the solution of which is discussed elsewhere.

$$\begin{matrix}ɛ = \frac{z}{{R}_{drop}} & Eq . 7 \\ {F}_{z} = π {R}_{drop}^{2} σ & Eq . 8\end{matrix}$$

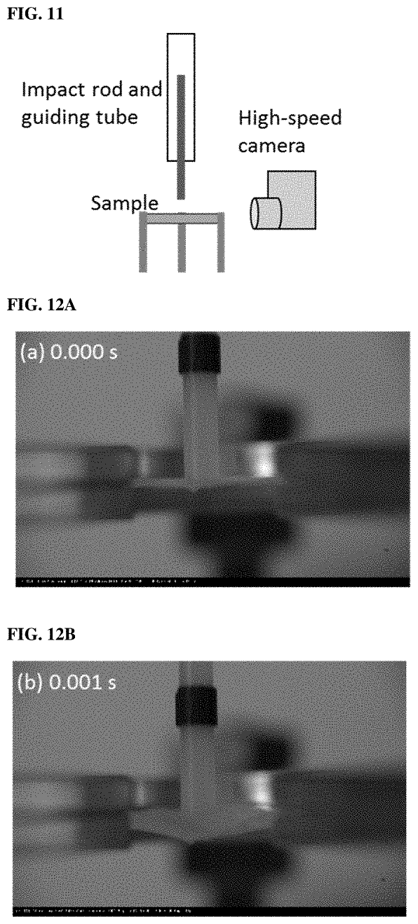

As shown in FIG. 11, in the case of STFs, there are clear differences between the moduli of FS15, FS18, and FS20. Namely, both the elastic and viscous moduli increase with particle loading, suggesting an increase in impact resistance.

The UFF-STF composites in general have improved moduli compared to the as-spun membranes, especially in terms of elasticity. Although both the elastic and viscous moduli increase with particle loading in the case of STFs, such trend is not observed in the case of the composites.

### Example 6: Exemplary Results and Discussion

### Shear-Thickening Fluids

Desired STF properties for the UFF-STF composite include significant shear-thickening behaviors for better mechanical reinforcement and moderate particle loading for ease of handling. Silica-based nanoparticles are commonly used in STF formulation. Several silica nanoparticles were screened for their applicability. One type was individual silica nanoparticles of different sizes, and another type was fumed silica (FS) nanoparticles. Table 11 summarizes the onset of shear-thickening for STFs made of several combinations of particle and carrying liquid. In comparison, the STF containing FS nanoparticles are superior, exhibiting higher degree of shear-thickening at lower shear rate and stress. In addition, the FS nanoparticles were easier to disperse in the carrying liquid due to lower particle loading, making them the most feasible option for STF formulation in this study. FIGS. 2A-2D show TEM images of the FS nanoparticles and the 100-200 nm individual spherical nanoparticles, respectively. The FS nanoparticles were highly irregular in shape, leading to larger ‘effective volume’ compared to regular-shaped particles of the same weight and thus allowed shear-thickening behaviors to begin at lower packing density.

TABLE 11
Properties of Known STF

| Particle type | Individual | Individual | Spherical | Spherical | Fumed-silica |
|---|---|---|---|---|---|
| Particle size (nm) | 60-70 | 400 | 100-200 | 100-200 | 200-300 |
| Liquid | PEG-200 | PEG-200 | PEG-200 | PEG-400 | PPG |
| ST onset loading (wt) | 35% | >60% | 65% | 60% | <15% |
| ST onset shear stress | 269.9 | NA | 638.5 | 496.0 | 12.6 |
| (Pa) | | | | | |
| ST onset shear rate | 100.0 | NA | 501.2 | 63.1 | 7.6 |
| (1/s) | | | | | |
| ST onset viscosity | 2.7 | NA | 1.3 | 7.9 | 1.7 |
| (Pa · s) | | | | | |

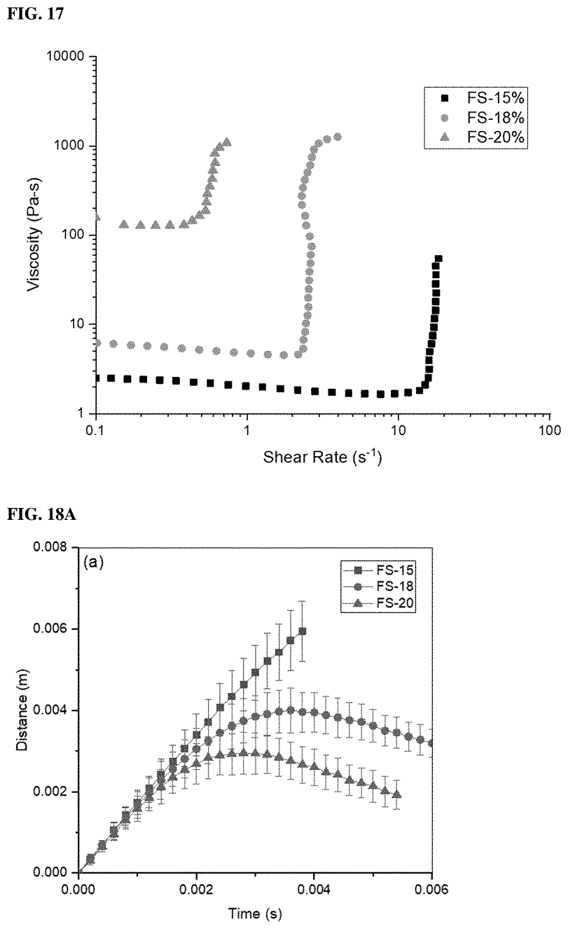

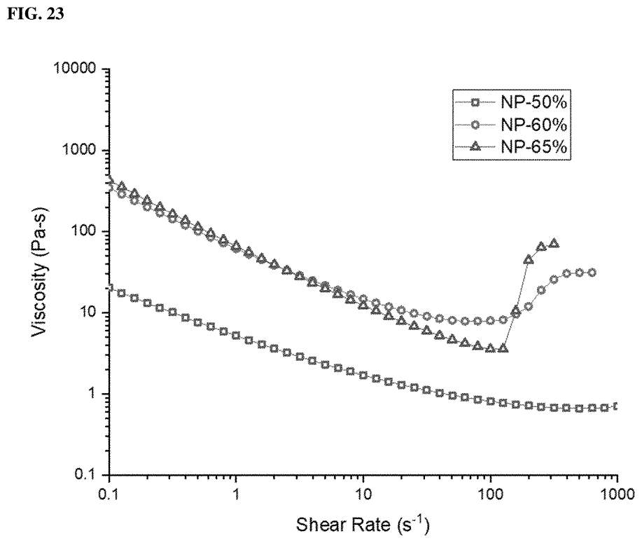

FIG. 17 shows the shear rheology measurements of the FS STFs with different particle loadings. Obvious shear-thickening behaviors were observed for all three FS STFs: FS-15, FS-18, and FS-20. The viscosity increases sharply at shear rates between 0.5 and 20 s⁻¹, suggesting rheological behaviors that are nearly discontinuous in shear-thickening. The results of the best-performing 100-200 nm spherical NP can be found in FIG. 23 for comparison. For both types of STFs, both the onset of shear-thickening and the viscosity increased with the particle loading. The FS-based STFs exhibited steeper increase in viscosity at significantly lower shear rate and lower particle loading than did the NP-based STFs.

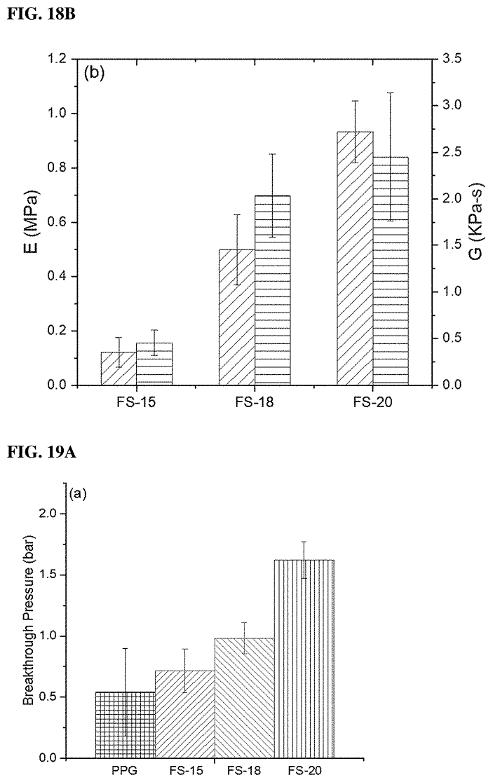

To probe STF behaviors at conditions relevant to the impact test of the composite, a similar impact test was also performed on the STFs. The impact velocity of 1.76±0.26 m/s used in the tests corresponded to an impact strain rate of around 1100 s⁻¹. FIGS. 18A & 18B shows the responses of bulk STFs under impact testing at strain rates 2 to 3 orders of magnitude greater than the shear-thickening thresholds shown in FIG. 17. The STF response is clearly dependent on the particle loading. Rebound of the drop object was observed for the STFs with higher particle loadings, FS-18 and FS-20. The drop object experienced the least penetration and the fastest rebound with the most viscous STF, FS-20. Compared to FS-15, FS-18 and FS-20 were more effective at decelerating the drop object due to more significant shear-thickening behaviors and higher viscosities (G), as shown in FIG. 18B. The rebound of the drop object from FS-18 and FS-20 also indicates higher elasticities (E), manifested as the ability of the STF to restore its original state after deformation. In addition, the viscosities measured during the impact test were higher than the base viscosities prior to the onset of shear-thickening shown in FIG. 17 for all three STFs, confirming that the shear-thickening behavior was indeed activated under the impact test condition in the z direction.

### Electrospun Ultrafine Fibers

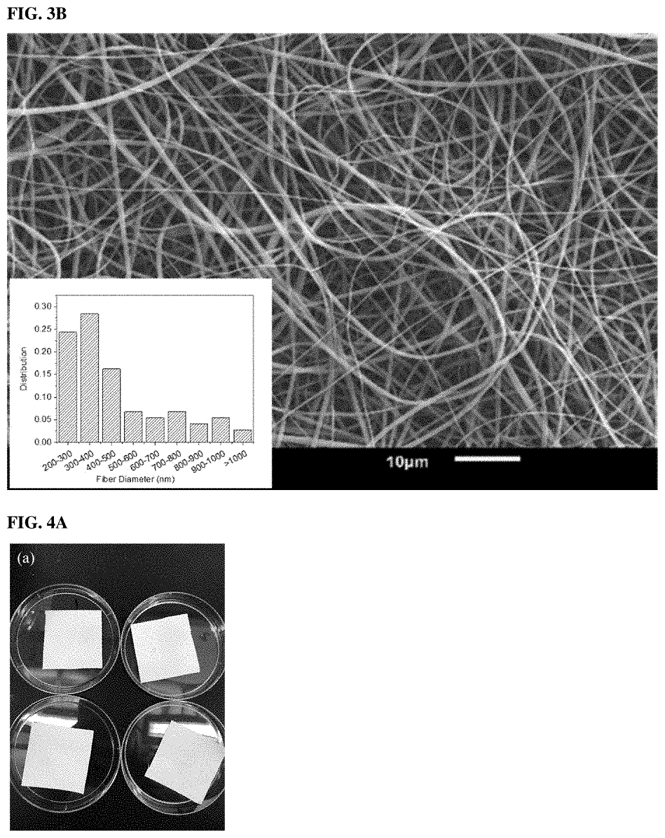

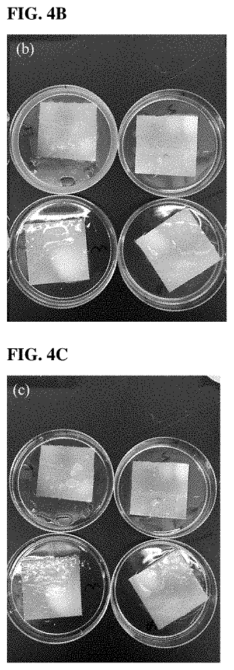

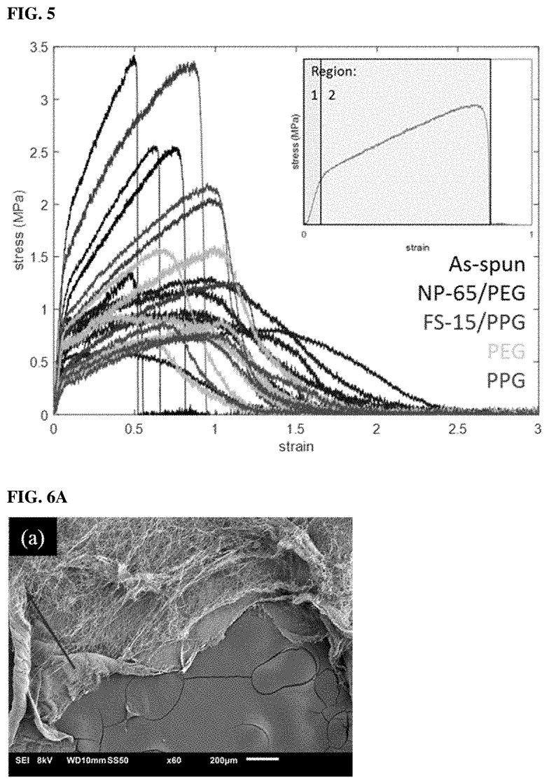

To take advantage of capillary forces to enhance the shape stability of the UFF-STF composite, the pore size of the electrospun mats should be small relative to the capillary length of the pore-filling fluid (approximately 1-2 mm for PPG), but large relative to the FS particles themselves, so that the STF can fully penetrate the mat. The effective pore size of electrospun mats has been shown empirically to be 3 to 5 times the diameter of the fiber. A fiber diameter around a few hundred nanometers was chosen to achieve an effective pore size on the micrometer scale. The average fiber diameters of the UFF mats used in this study, PA12 and PA15, were between 200 nm and 500 nm. The solidities, or solid volume fractions, were between 0.10 and 0.15. An SEM image of the PA15 fibers and the corresponding fiber diameter distribution are shown in FIG. 3B.

### Composite Structure and Shape Stability

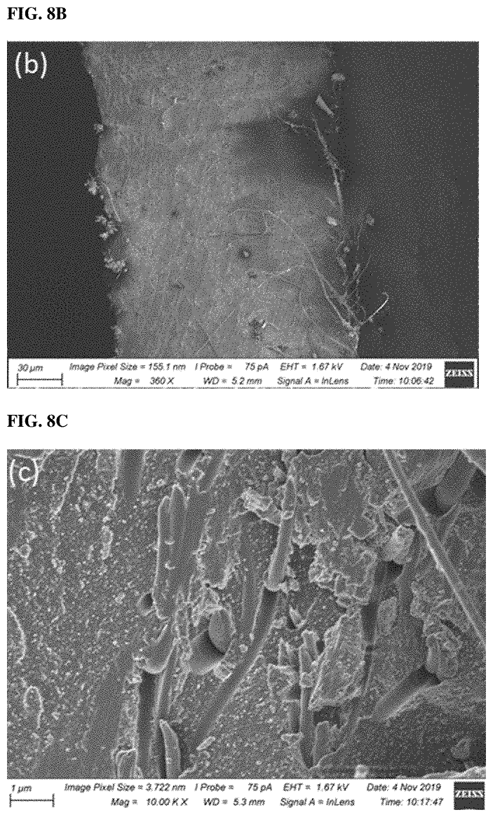

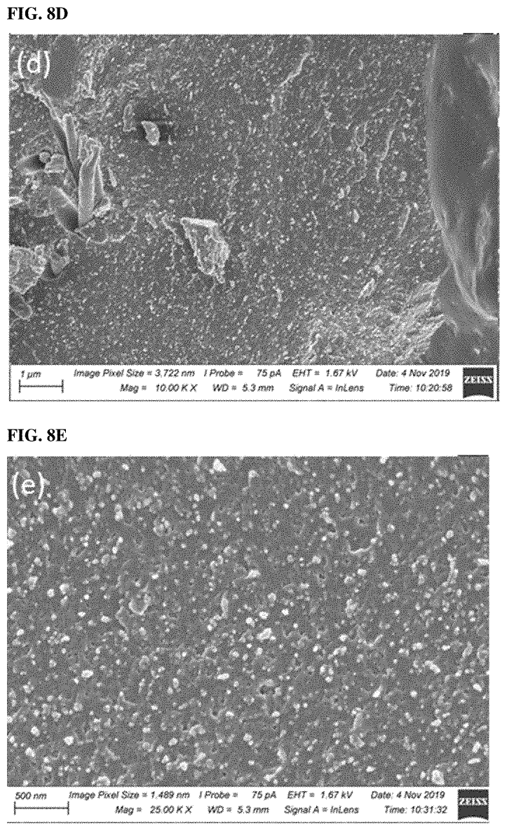

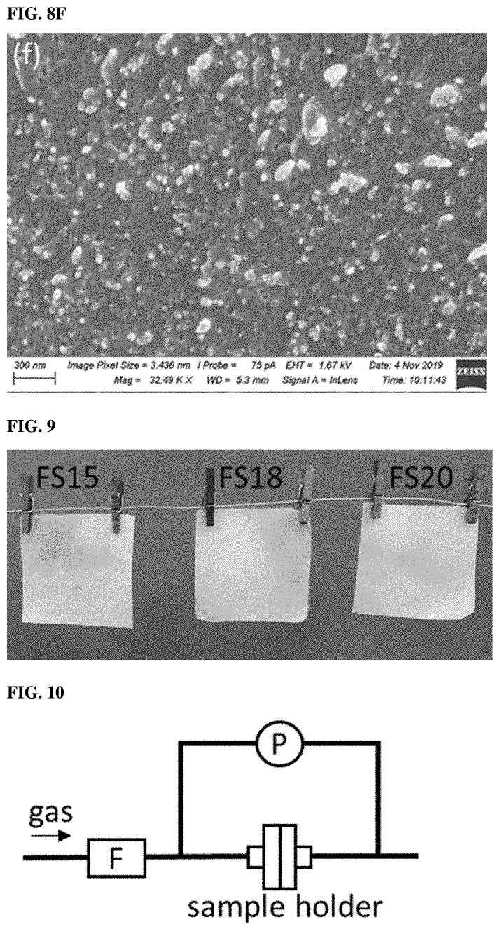

The cryo-SEM images of the cross-section of the UFF-STF composite, shown in FIGS. 8A-8F, provide a microscopic view of the structural homogeneity of the composite and demonstrate that the STF was completely integrated into the mat. No air pockets or unfilled spaces were observed. In addition, the FS nanoparticles in the STF, visible as the bright spots, were distributed evenly throughout the composite, with no evidence of aggregation around the fibers.

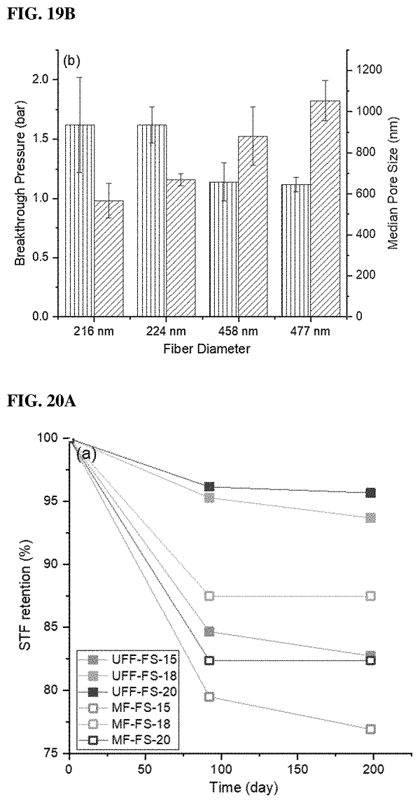

The effect of STF particle loading and membrane morphology on breakthrough pressure was investigated. FIG. 19A shows the breakthrough pressure of a PA12 UFF mat (average fiber diameter of 224±35 nm) impregnated with STFs of different FS loadings, as well as with only the carrying liquid PPG. Due to the affinity between the PPG and the PA 6,6 polymer, electrospun mats impregnated with only PPG already exhibit relatively high breakthrough pressure. The breakthrough pressure increased further with increasing FS nanoparticle concentration. A significant improvement was observed for the FS-20 composite. One explanation for the increase in breakthrough pressure is the dependence of surface tension of the STF on FS concentration. FIG. 7B shows the breakthrough pressure as well as the effective median pore size of four electrospun mats with mean fiber diameters between 200 nm and 500 nm that were impregnated with FS-20. All four composites appeared highly stable, with breakthrough pressure greater than 1 bar. Composites consisting of small fiber diameters had smaller effective pore sizes and exhibited higher breakthrough pressure compared to those made of larger fibers. Since the capillary force is inversely related to the pore dimension), electrospun mats comprising smaller fibers and smaller pores were able to retain the STF more stably.

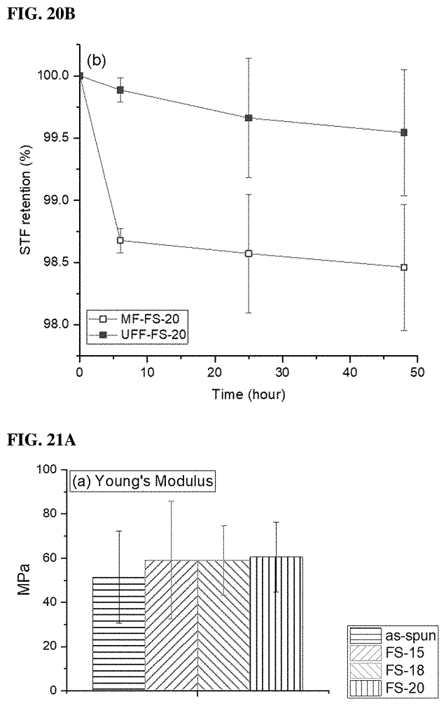

To evaluate the STF retention capability of the membranes, a 198-day long-term exposure study under ambient conditions and a 2-day exposure study at elevated temperature were conducted, during which the loss of STF was measured. Commercial nylon fabrics made of woven microfibers (fiber diameter around 20 μm) were impregnated with STFs and compared side-by-side with the electrospun mats, as shown in FIGS. 20A & 20B. No dripping was observed for either the commercial or the electrospun composites, although STF loss due to gravity could become an issue if the STF had lower viscosity or surface tension. However, evaporation was found to be a challenge to STF retention. FIG. 20A shows that electrospun mats were able to retain a higher fraction of STF compared to commercial fabrics over a long period of time. FIG. 20B shows the comparison of STF retention at 50° C., demonstrating that electrospun UFF mats also outperformed commercial MF fabrics at elevated temperature and barely lost any fluid. Interestingly, the amount of STF loss decreased with increasing particle loading of the STF. A possible explanation is that the increase in particle loading lowers the effective concentration of PPG in the STF, and thus its chemical potential, thereby reducing the driving force for evaporation.

### Effects of STF Nanoparticle Loading on Mechanical Properties

The mechanical properties of the UFF-STF composites were evaluated under two deformation scenarios: 1) slow deformation during tensile tests; 2) fast deformation during impact tests. The responses of the composites under different deformation rates were compared. The influence of STF rheology on the overall mechanical properties of the composite was first investigated by examining composites comprising STFs of different nanoparticle loadings. The composites were formed by impregnating an electrospun mat (fiber diameter 343±132 nm; solidity 0.13±0.01) with FS-15, FS-18, and FS-20, respectively.

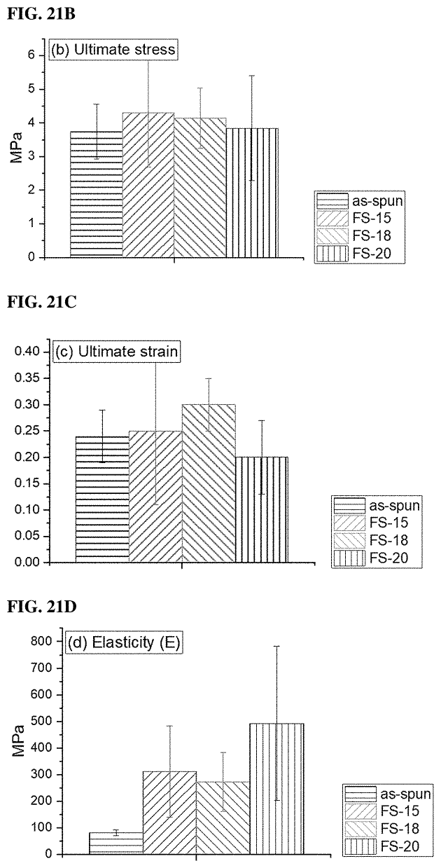

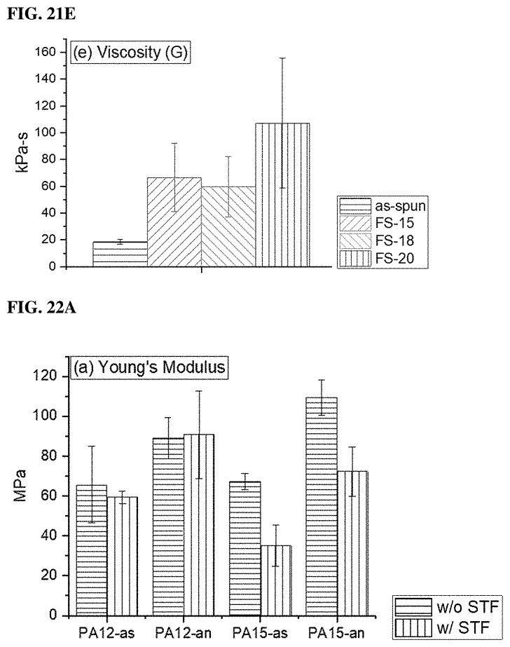

FIGS. 21A-21C show the Young's modulus, the ultimate stress (breaking strength), and the ultimate elongation (strain-at-break) of the three composites in comparison with those of the neat electrospun mat (no STF). No improvement in stiffness or strength was observed for the composites, as neither the Young's modulus (E) nor the ultimate stress showed meaningful changes with the addition of the STFs. This result confirms that at the low strain rate employed in tensile testing, no shear-thickening occurred. Based on the viscosity measurements shown in FIG. 3, the stress contribution from the STFs during such slow deformation was orders of magnitude smaller than the stress measured for the whole composite. Therefore, no enhancement from shear-thickening was to be expected.

Fits of the Kelvin-Voigt model to the displacement versus time data for impact testing of the samples were obtained. From those fits, the elasticity (E) and the viscosity (G) of the Kelvin-Voigt model calculated from the impact test results are shown in FIGS. 21D & 21E. Contrary to the lack of improvement in mechanical properties under the tensile testing conditions, incorporation of all three STFs significantly increased both the elasticity and the viscosity of the composite membrane during the impact tests, indicating that the shear-thickening effect was operative. The higher elasticity represents an improved stiffness of the composites, and the higher viscosity suggests that the composites have greater capacity to dissipate energy compared to the neat electrospun mat. Among the STFs with different nanoparticle loadings, FS-20 resulted in the largest increase in both E and G. This trend is consistent with the rheological measurements of pure STFs, where FS-20 exhibited the highest viscosity and the most significant shear-thickening. In addition, since the STF facilitates dissipation of energy over a larger area of the sample,¹ the denser network of nanoparticles between fibers in FS-20 composites should be the most effective at transferring the load. Studies on commercial fabrics treated with STFs suggest that the increase in frictional interactions between fibers and between the fabric and the drop object are the major mechanisms through which the STFs enhance the impact resistance of the fabrics.²²⁻²⁴ While the commercial fabrics used in those studies were woven microfibers, it is reasonable to expect that the STF can similarly increase the frictional interactions between nanofibers in electrospun nonwoven mats. Due to its high particle loading and high viscosity, FS-20 resulted in the largest observed frictional force between fibers and was thus most effective at hindering fiber movement, leading to the biggest improvement in both the elasticity and the viscosity compared to FS-15 and FS-18.

### Effects of UFF Membrane Morphology on Mechanical Properties

To investigate the effect of the UFF component on the mechanical responses of the composites, UFF-STF composites were fabricated with different types of UFF mats. Electrospun mats consisting of fibers in two size ranges (around 220 nm and above 450 nm) were tested either as-spun or after annealing, resulting in four combinations of the UFF systems: PA12-as (small fiber size, as-spun), PA12-an (small fiber size, annealed), PA15-as (large fiber size, as-spun), and PA15-an (large fiber size, annealed). Each UFF was treated with the FS-20 STF to form the corresponding composite. FS-20 STF was used for this study, as it was shown in the previous section to provide the most pronounced enhancement to the mechanical properties of the composite. Relevant properties of the fiber mats and the composites are listed in Table 1.

FIGS. 21A-21C compare the mechanical properties of the composites with those of the neat electrospun mats for the four UFF systems. First, the improvement in the Young's modulus and the ultimate stress indicate that annealing stiffened and strengthened both the PA12 and the PA15 mats. As reported in the literature for electrospun PA 6,6 UFFs, annealing above the Brill transition temperature (T_{B}) leads to a transformation of the triclinic crystalline structure to a pseudo-hexagonal structure, which reverts back to the triclinic form upon cooling. Second, the incorporation of STF did not alter the ultimate stress to any significant degree, consistent with the results from the previous section. The effects of the STF on the Young's modulus and the ultimate elongation, nonetheless, appear to depend on the structure of the UFF mat. Incorporation of the STF resulted in no significant change in the Young's modulus and only moderate increases in the ultimate elongation for the PA12 UFFs, which comprise small-diameter fibers. On the other hand, the Young's modulus for mats of the larger fibers (PA15 UFFs) decreased with the addition of STF, while the ultimate elongation increased significantly. FIGS. 19A & 19B shows that larger fiber size corresponds to larger pore size, and Table 12 reveals that the PA15 composites also had a higher STF/fiber weight ratio. Both characteristics would indicate a lower density of fiber-fiber junctions in the PA15 composites, which decreased the stiffness and increased the elongation by facilitating the rearrangement of fibers.

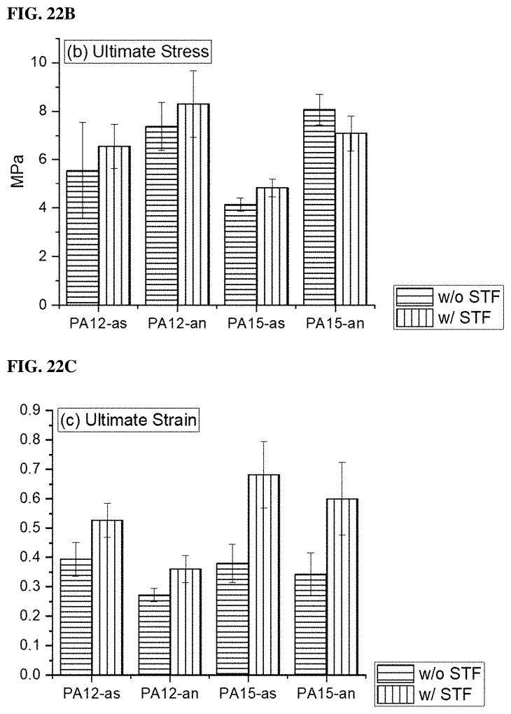

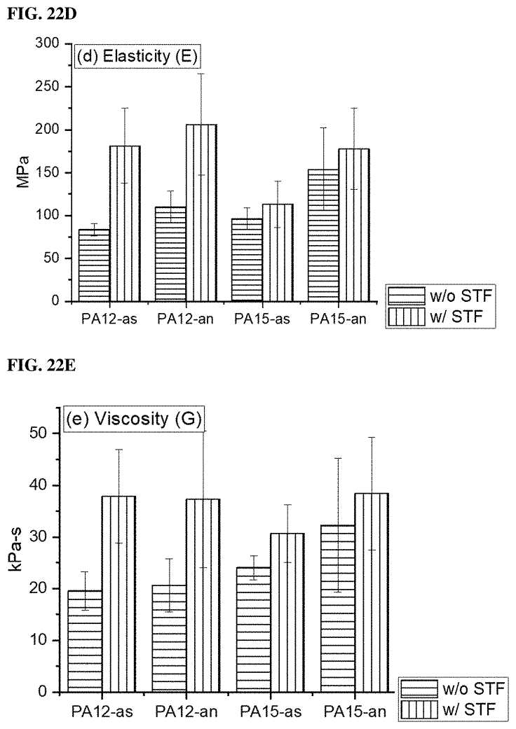

The Kelvin-Voigt parameters for elasticity and viscosity from the impact test of the PA12 and PA15 composites are shown in FIGS. 22D & 22E. The elasticity of the neat electrospun mats exhibited the same trend as that observed in tensile tests, with PA15-an being the stiffest. The neat PA15 mats exhibited slightly higher viscosities than the neat PA12 mats under impact, implying higher degree of frictional loss even in the absence of STF, likely from fiber sliding. The sliding could be the result of fewer contact points between fibers in the PA15 membranes, as a previous study has demonstrated both experimentally and theoretically that the junction distance in electrospun mats scales with fiber diameter. While the incorporation of STF increased both E and G in all UFF systems, the degree of the improvement was found to vary with the fiber diameter of the UFF mat, with the PA15 mats experiencing smaller increases than the PA12 mats. We speculate that the larger enhancement of modulus by the STF in the PA12 composites can be attributed to the higher density of fiber-fiber junctions in PA12 mats.

There have been debates about whether the improvement of the mechanical responses in fiber-STF composites is indeed caused by the shear-thickening effect of the STFs, or whether the improvement is simply due to fiber movements made difficult by the addition of nanoparticles and viscous fluids. In the case of the STF-UFF composites developed in this study, the different mechanical responses under slow and fast deformation demonstrate that the shear-thickening effect indeed took place and led to the enhanced elasticity and viscosity. The comparison between the different types of mats serves as a further indication that the structure of the fiber network also plays an important role.

TABLE 12
PA 6,6 UFF mat and composite properties.

| | PA12-as | PA12-an | PA15-as | PA15-an |
|---|---|---|---|---|
| Fiber Diameter (nm) | 224 ± 35 | 216 ± 54 | 477 ± 250 | 458 ± 138 |
| Mat Solidity | 0.13 ± 0.04 | 0.11 ± 0.01 | 0.13 ± 0.02 | 0.13 ± 0.01 |
| STF/UFF mass ratio | 8.4 ± 0.8 | 9.4 ± 1.0 | 15.2 ± 1.2 | 12.2 ± 0.5 |

### SUMMARY

A new composite consisting of electrospun PA 6,6 UFF mats and FS-based STFs were developed to improve the shape stability of STF-impregnated fabrics. The composites were demonstrated to be shape-stable with high breakthrough pressure due to the small effective pore size and the high capillary force of the UFF membranes. Compared to commercial microfiber fabrics, UFF mats exhibited an improved capability of retaining STF both over long periods of time and at elevated temperature. The mechanical properties of the composites were shown to depend on the deformation rate. Under deformation rates slower than the threshold for the onset of shear-thickening, the composite experienced no mechanical enhancement from the STFs, allowing the material to maintain its original flexibility. At high deformation rates beyond the shear-thickening threshold, both the elasticity and the viscosity of the UFF-STF composite increased. The viscosity of the STF and the properties of the UFF were found to influence the shape stability and the mechanical responses of the composites. More viscous STF and UFF with smaller fiber diameter led to a more pronounced improvement in composite performance. This study demonstrates that electrospun UFF mats, with their small pore size and high capillary forces, can improve the fluid-retention capability of liquid-solid composites, such as those with potential use in protective clothing. In addition, the examination of the composite's mechanical responses provides insights into the deformation of nonwoven mats and highlights the importance of the fiber network on the overall mechanical properties. While the UFF-STF composites studied here do not exhibit the same level of mechanical strength of a Kevlar fabric, due to use of PA 6,6 fibers, the UFF could be combined with commercial fabrics to bridge large pores between the microfibers and improve STF retention. Moreover, further development in the production of high-performance UFFs, such as the electrospinning or centrifugal spinning of Kevlar or UHMWPE fibers, could allow electrospun UFF-STF composite to be used as stand-alone material in the future.

### INCORPORATION BY REFERENCE

All publications and patents mentioned herein are hereby incorporated by reference in their entirety as if each individual publication or patent was specifically and individually indicated to be incorporated by reference. In case of conflict, the present application, including any definitions herein, will control.

### EQUIVALENTS

While specific embodiments of the subject invention have been discussed, the above specification is illustrative and not restrictive. Many variations of the invention will become apparent to those skilled in the art upon review of this specification and the claims below. The full scope of the invention should be determined by reference to the claims, along with their full scope of equivalents, and the specification, along with such variations.

1. A fabric, comprising a plurality of polymer fibers and a shear-thickening fluid; wherein the polymer fibers have a diameter from 1-1,500 nm; and the shear-thickening fluid comprises a plurality of nanoparticles or aggregates, and a suspending liquid.

2. The fabric of claim 1, wherein the polymer fibers are ultrafine.

3. The fabric of claim 1, wherein the polymer fibers are nanofibers.

4-6. (canceled)

7. The fabric of claim 1, wherein the polymer fibers comprise a polyamide, a polyolefin, a polyimide, a polyester, a polysaccharide, or a polypeptide.

8. The fabric of claim 1, wherein the polymer fibers comprise aramid or polyolefin.

9. (canceled)

10. The fabric of claim 1, wherein the fibers comprise wood fibers, plant fibers, or silk fibers.

11. The fabric of claim 1, wherein the polymer fibers comprise nylon or polyethylene.

12. The fabric of claim 1, wherein the polymer fibers comprise poly(trimethylhexamethylene terephthalamide), poly(hexamethylene adipamide), poly(p-phenylene terephthalamide), or poly(m-phenylene isophthalamide).

13-23. (canceled)

24. The fabric of claim 1, wherein the diameter of the polymer fibers is 1 nm-1,000 nm.

25-32. (canceled)

33. The fabric of claim 1, wherein the shear-thickening fluid comprises a plurality of nanoparticles; and the nanoparticles comprise metal oxides, calcium carbonate, silica, or cornstarch.

34-39. (canceled)

40. The fabric of claim 1, wherein the nanoparticles comprise 30%-70% by weight of the shear-thickening fluid.

41-45. (canceled)

46. The fabric of claim 1, wherein the shear-thickening fluid comprises a plurality of aggregates; and the aggregates comprise fumed silica.

47. (canceled)

48. The fabric of claim 1, wherein the aggregates or nanoparticles are 50 nm-500 nm in diameter.

49. (canceled)

50. The fabric of claim 46, wherein the aggregates comprise 5%-20% by weight of the shear-thickening fluid.

51-54. (canceled)

55. The fabric of claim 1, wherein the suspending liquid is an alcohol or water.

56. (canceled)

57. (canceled)

58. The fabric of claim 1, wherein the suspending liquid is poly(ethylene)glycol or poly(propylene glycol).

59-62. (canceled)

63. The fabric of claim 1, wherein the shear-thickening fluid is impregnated among polymeric fibers.

64. The fabric of claim 1, wherein the thickness of the fabric is 1-10 mm.

65-80. (canceled)

81. An article of clothing, comprising the fabric of claim 1.

82-84. (canceled)

85. A method of making the fabric of claim 1, comprising the steps of:
contacting the shear-thickening fluid with an alcohol, thereby forming a solution;
contacting the solution with the plurality of polymeric fibers; and
removing the alcohol, thereby forming the fabric.

86-88. (canceled)
